(19) United States
(12) Patent Application Publication
(10) Pub. No.: US 2007/0086434 A1
(43) Pub. Date: Apr. 19, 2007

(54) Efficient mechanisms for supporting VoIp in a wireless network

(76) Inventors: Muthaiah Venkatachalam, Beaverton, OR (US); Shailender Timiri, Hillsboro, OR (US)

Correspondence Address: The Law Offices of John C. Scott, LLC;c/o PortfolioIP, P.O. Box 52050, Minneapolis, MN, 55402, US

(21) Appl. No.: 11/253,835

(22) Filed: Oct. 19, 2005

(51) Int. Cl. H04L 12/66

(52) U.S. Cl. 370/352; 370/389

(57) ABSTRACT

Voice over IP (VoIP) packet header compression is performed for voice packets to be transmitted through a wireless channel. In at least one embodiment, packet headers are compressed to a fixed size that does not change based on channel conditions. In this manner, packet scheduling may be performed in the network in a reliable and efficient manner.

### TECHNICAL FIELD

The invention relates generally to wireless networking and, more particularly, to voice communication within a wireless network.

### BACKGROUND OF THE INVENTION

The popularity of wireless networking is growing due to, among other things, the convenience and simplicity it provides to users. Broadband wireless local area networks (LANs) within buildings are now commonplace. Solutions for providing broadband wireless network coverage over extended coverage regions (e.g., wireless wide area networks (WANs)) are now in development. The IEEE 802.16 standard, for example, sets out an architecture that is designed to address the wireless broadband last mile problem, while also supporting nomadic and mobile users. It is desired that the IEEE 802.16 standard will eventually lead to the deployment of high speed wireless networks that provide data services over extended portions of urban areas and along public thoroughfares.

One of the services that will most likely occupy a significant portion of the available bandwidth in a broadband wireless WAN is voice services. That is, voice communication, like that now provided by the public switched telephone network or cellular wireless systems, may soon be available over these broadband wireless networks. Voice over IP (VoIP) is a protocol that supports the transmission of voice signals over digital data networks using packet-based communication. To provide voice services through high speed wireless WAN networks and other wireless networks, techniques need to be developed that will allow the available bandwidth to be used in an efficient manner, while still maintaining a quality voice connection.

### BRIEF DESCRIPTION OF THE DRAWINGS

FIG. 1 is a block diagram illustrating a wireless network arrangement in accordance with an embodiment of the present invention;

FIG. 2 is a block diagram illustrating another wireless network arrangement in accordance with an embodiment of the present invention;

FIG. 3 is a flowchart illustrating a method for use in processing a VoIP packet to be transmitted to a remote wireless entity in a wireless network in accordance with an embodiment of the present invention;

FIG. 4 is a flowchart illustrating a method for use in processing a voice packet received from a wireless channel in accordance with an embodiment of the present invention;

FIG. 5 is a flowchart illustrating another method for use in processing a voice packet received from a wireless channel in accordance with an embodiment of the present invention; and

FIG. 6 is a flowchart illustrating still another method for use in processing a voice packet received from a wireless channel in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention relates to methods and structures that allow voice services to be provided within high speed wireless networks in an efficient manner. The invention provides unique strategies for performing voice packet header compression before a packet is transmitted through a wireless channel. Features of the invention may be used within wireless networks following the IEEE 802.16 standard as well as other high speed wireless networking standards. In at least one embodiment, the invention is capable of generating a fixed packet header size after compression, regardless of channel conditions. For this reason, the invention is particularly well suited for use in wireless networks where centralized traffic scheduling is performed (such as an IEEE 802.16 network). Because the length of the compressed header is constant, a scheduler in such a network will know how much bandwidth to allocate to each subscriber station without having to predict the length of a variable length header. The inventive techniques are capable of making efficient use of the available bandwidth within a wireless network and, therefore, can significantly increase the throughput achievable in these networks.

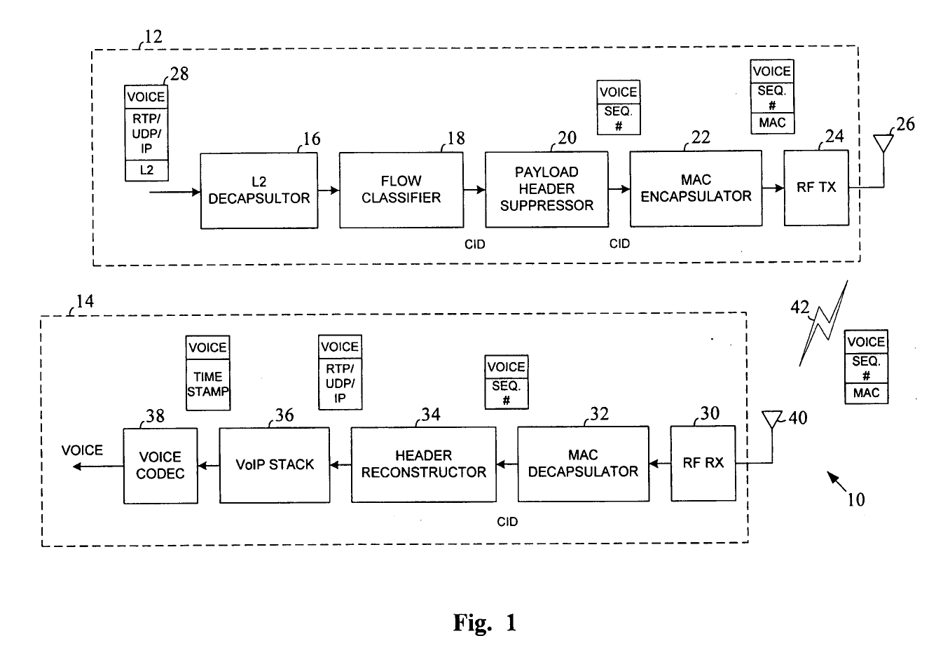

FIG. 1 is a block diagram illustrating a wireless network arrangement 10 in accordance with an embodiment of the present invention. As shown, the wireless network arrangement 10 includes a first wireless device 12 communicating with a second wireless device 14 through a wireless communication link 42. As depicted, the first wireless device 12 is a transmitting device and the second wireless device 14 is a receiving device. A similar arrangement may be used in the reverse direction. The first wireless device 12 may be, for example, a base station and the second wireless device 14 may be a subscriber station, or vice versa. In either scenario, the wireless base station may also be communicating with one or more other wireless subscriber stations at the same time that it is communicating with the subscriber station of interest. As used herein, the term “subscriber station” refers to any component, device, or system that can communicate wirelessly with a base station, and may be stationary, portable, or mobile. As will be described in greater detail, the wireless network arrangement 10 of FIG. 1 is capable of providing voice services to a user associated with a corresponding subscriber station in a relatively efficient manner, utilizing voice over Internet Protocol (VoIP) techniques. In the discussion that follows, the wireless network arrangement 10 will be described in the context of an IEEE 802.16 based network. It should be appreciated, however, that features of the present invention may also be implemented in wireless networks following other wireless networking standards and protocols.

With reference to FIG. 1, the first wireless device 12 may include: an L2 decapsulator 16, a flow classifier 18, a payload header suppressor (PHS) 20, a MAC encapsulator 22, and a radio frequency (RF) transmitter 24. The RF transmitter 24 may be coupled to one or more antennas 26 to facilitate the transmission of RF signals into the wireless channel. Any type(s) of antenna may be used including, for example, a dipole, a patch, a helical antenna, an antenna array, and/or others. During a VoIP based communication, the first wireless device 12 will acquire a stream of VoIP packets that each contain a portion of a voice message to be delivered to a remote entity (e.g., second wireless device 14). The first wireless device 12 will process each VoIP packet in the stream to generate an RF signal that can be transmitted through the wireless channel to the second wireless device 14. The second wireless device 14 receives the RF signals from the wireless channel and processes the signals in a manner that allows the original voice message to be reconstructed. As described previously, in at least one embodiment, the network arrangement 10 occurs within a network following the IEEE 802.16 standard.

During network operation, a first VoIP packet 28 is obtained by the first wireless device 12. In a scenario where the first wireless device 12 is a base station, the VoIP packet 28 may be received from a remote user location through, for example, a wired network (e.g., the Internet, a private network, etc.) or other communication connection. In a scenario where the first wireless device 12 is a subscriber station, the VoIP packet 28 may be received from a local voice codec processing voice signals of a corresponding user. Other sources are also possible. As shown, the VoIP packet 28 includes a voice payload portion that includes digital voice information, an RTP (real-time transfer protocol) header, a UDP (user datagram protocol) header, an IP (Internet protocol) header, and an L2 header. The VoIP packet 28 is first applied to the L2 decapsulator 16 which removes the L2 header from the packet. The resulting packet is then delivered to the flow classifier 18 which generates a connection ID (CID) value that uniquely identifies the communication connection associated with the VoIP packet 28. Classification rules are set up within the flow classifier 18 in a manner that generates a unique CID using information within the UDP header and the IP header of the VoIP packet 28. For example, classification rules may be set up so that the 4-tuple combination of [source IP address, destination IP address, source UDP port, and destination UDP port] is unique for the corresponding voice call at the subscriber station and the base station. The flow classifier 18 may perform a classification based on the 4-tuple of the incoming VoIP packet 28 to generate a unique CID value corresponding to the voice call. As will be described in greater detail, this CID may later be used to regenerate the corresponding 4-tuple.

The payload header suppressor 20 receives the VoIP packet 28 and the CID from the flow classifier 18 and proceeds to remove the RTP, UDP, and IP headers from the packet. The only information within the RTP header that is of any use within the second wireless device 14 is the time stamp and the sequence number of the VoIP packet 28. However, because the voice frames at the voice codec are generated at set intervals, if the sequence number of the packet is known, the time stamp may be easily calculated. Therefore, the signal transmitted to the second wireless device 14 can include only the sequence number and the second wireless device 14 will be able to recreate the time stamp. Alternatively, the signal transmitted to the second wireless device 14 may include only the time stamp, with the sequence number being recreated in the second wireless device 14 (although this is less efficient as the time stamp is generally longer (i.e., more bytes) than the sequence number). Before the payload header suppressor 20 removes the RTP header from the VoIP packet 28, it reads the sequence number from the header. The payload header suppressor 20 may subsequently append the sequence number to the VoIP packet after the RTP, UDP, and IP headers have been removed. A payload header suppression function is available as part of the IEEE 802.16 standard and may be used to perform the above described functions. It will be necessary, however, to appropriately configure the function within an IEEE 802.16 device to achieve the desired header suppression.

The modified VoIP packet is next delivered to the MAC encapsulator 22 which generates and appends an IEEE 802.16 MAC header to the packet (or other form of MAC header when other wireless standards are being used). The MAC header will include the CID generated previously by the flow classifier 18. The MAC header may also include cyclic redundancy check (CRC) information. In at least one embodiment, the MAC header that is generated includes a 6 byte CID and a 4 byte CRC for a total of 10 bytes. Other sizes may alternatively be used.

The modified VoIP packet including the original voice payload, the sequence number, and the MAC header is next delivered to the RF transmitter 24 to be transmitted into the wireless channel. The RF transmitter 24 will typically be configured in accordance with one or more wireless networking standards. As described previously, in at least one embodiment, the RF transmitter 24 is configured in accordance with the IEEE 802.16 wireless networking standard. The modified VoIP packet is used to generate a transmit signal or signals by the RF transmitter 24. The transmit signal may then be transmitted into the wireless channel via antenna 26.

With reference to FIG. 1, the second wireless device 14 may include: an RF receiver 30, a MAC decapsulator 32, a header reconstructor 34, a VoIP stack 36, and a voice codec 38. The RF receiver 30 is operative for receiving RF signals transmitted to the second wireless device 14. The RF receiver 30 receives the RF signal that was transmitted into the wireless channel that includes the original voice payload, the sequence number, and the MAC header and converts the signal to a baseband representation. The RF receiver 30 may be coupled to one or more antennas 40 to facilitate the reception of signals from the wireless channel. The RF receiver 30, or some other structure, may perform an error detection/correction operation on the received packet using the CRC data within the MAC header of the packet. The MAC decapsulator 32 reads the CID information from the MAC header of the received packet and then removes the MAC header from the packet. The header reconstructor 34 then receives the packet and the CID and uses the CID to reconstruct the UDP header and the IP header of the original VoIP packet. In at least one embodiment of the invention, the header reconstructor 34 performs a lookup to determine a source IP address, a destination IP address, a source UDP port, and a destination UDP port that correspond to the CID. Other information may alternatively be recovered. Any fields of the UDP header and the IP header for which information is not recovered from the CIP may be filled with default (dummy) values (e.g., ones, zeros, etc.) by the header reconstructor 34.

In addition to reconstructing the UDP and IP headers, the header reconstructor 34 may also reconstruct the RTP header of the original VoIP packet. To do this, the header reconstructor 34 first uses the sequence number within the received packet to calculate the time stamp associated with the packet. This time stamp, along with the sequence number, may then be entered into corresponding fields of the reconstructed RTP header. Any fields of the RTP header for which information is not available may be filled with dummy values during the reconstruction. The reconstructed headers may be appended to the voice payload of the received packet to form a reconstructed VoIP packet. The VoIP packet may then be delivered to the VoIP stack 36 which process the RTP, UDP, and IP headers in a known manner. If the second wireless device 14 is a subscriber station, the VoIP stack 36 will typically be local. If, on the other hand, the second wireless device 14 is a base station, the VoIP stack 36 will most likely be located at the destination node. In such a case, the second wireless device 14 may include a transmitter for transmitting the reconstructed VoIP packet to the destination node through an intervening network (e.g., the Internet, etc.). The VoIP stack 36 will output the voice payload along with the corresponding time stamp to the voice codec 38. In this manner, a stream of voice payloads with corresponding time stamps are delivered to the voice codec 38. The voice codec 38 may then covert this stream of digital voice information into an audible voice signal. The audible voice signal may then be delivered to a loudspeaker (not shown) so that it may be heard by the corresponding user.

In at least one implementation, a VoIP packet having a voice payload of 20 bytes is generated every 20 milliseconds (msec) by a voice codec associated with the first wireless device 12. The first wireless device 12 then processes each packet to generate an RF signal that includes the 20 byte voice payload, a 10 byte MAC header, and a 2 byte sequence number. Thus, a significant amount of header compression has been achieved. In other implementations, more or less compression may be achieved using the inventive techniques. The invention is capable of achieving a fixed header size after compression. The compression achieved by removing the UDP header and the IP header from the packet and, instead, using the CID to reconstruct these headers in the receiving unit may be implemented without using the sequence number technique. Likewise, the compression achieved by removing the RTP header and, instead, including only the sequence number within the packet transmitted into the wireless channel may be implemented without the CID technique.

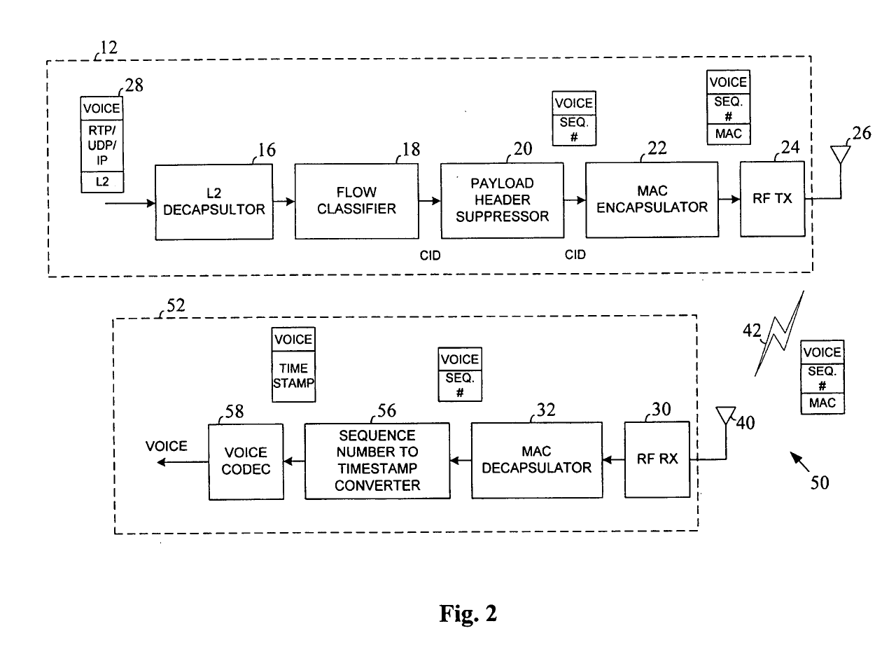

FIG. 2 is a block diagram illustrating a wireless network arrangement 50 in accordance with an embodiment of the present invention. The wireless network arrangement 50 is similar to the arrangement 10 of FIG. 1, except for certain modifications made within the receiving device. As in FIG. 1, the wireless network arrangement 50 of FIG. 2 includes a first wireless device 12 communicating with a second wireless device 52 through a wireless link 42. In the new arrangement, however, the second wireless device 52 can only be the subscriber station and the first wireless device 12 is the base station. The arrangement 10 of FIG. 1 may still be used for the uplink scenario. As shown, the second wireless device 52 includes, as before, an RF receiver 30 and a MAC decapsulator 32. However, instead of reconstructing the RTP, UDP, and IP headers as before, the second wireless device 52 only converts the sequence number within the received signal into a corresponding time stamp. This is performed in the sequence number to time stamp converter 56. The voice payload and the corresponding time stamp may then be input directly to the voice codec 58 to be converted into an audible signal. Use of this technique dispenses with the need to process the CID to recover the IP and UDP headers. The technique also dispenses with the need to utilize the VoIP stack to process the recovered headers. Thus, a significant amount of processing can be bypassed when the receiving entity is a subscriber station. If the receiving entity is a base station, however, additional packet routing is required for the VoIP packets to reach their final destination and, therefore, packet header reconstruction is required.

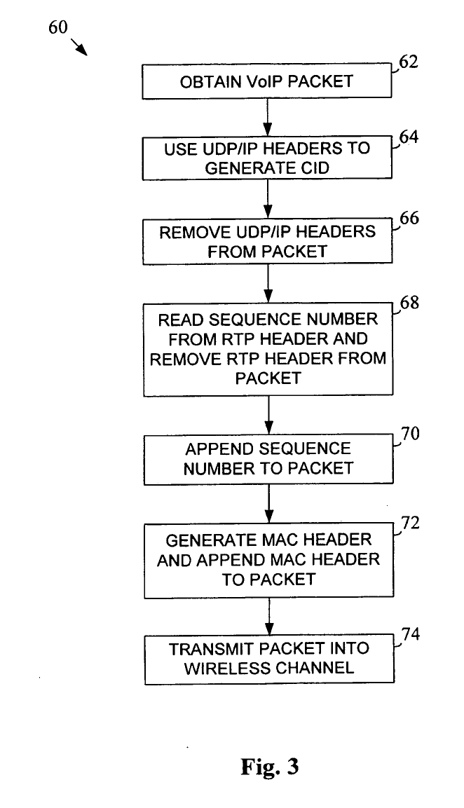

FIG. 3 is a flowchart illustrating a method 60 for use in processing a VoIP packet to be transmitted to a remote wireless entity in a wireless network in accordance with an embodiment of the present invention. The method 60 may be performed within a base station or a subscriber station in the wireless network. First, a VoIP packet is obtained (block 62). The VoIP packet has at least a voice payload, an RTP header, a UDP header, and an IP header. The UDP header and the IP header are next used to generate a CID for the corresponding connection that uniquely identifies the connection (block 64). In one approach, this CID may be generated by performing a classification using the 4-tuple combination of [source IP address, destination IP address, source UDP port, and destination UDP port]. Other techniques for generating the CID may alternatively be used. The UDP header and the IP header may then be removed from the packet (block 66). The sequence number of the packet may next be read from the RTP header and the RTP header may then be removed from the packet (block 68). The sequence number may then be appended to the packet (block 70). A MAC header (e.g., an IEEE 802.16 MAC header) may then be generated and appended to the VoIP packet (block 72). The MAC header is to include the CID generated previously. The MAC header may also include error detection and/or correction information (e.g., a CRC value, etc.). The modified packet may then be transmitted into the wireless channel (block 74). Any type of RF transmission technique may be used including OFDM, CDMA, and/or others.

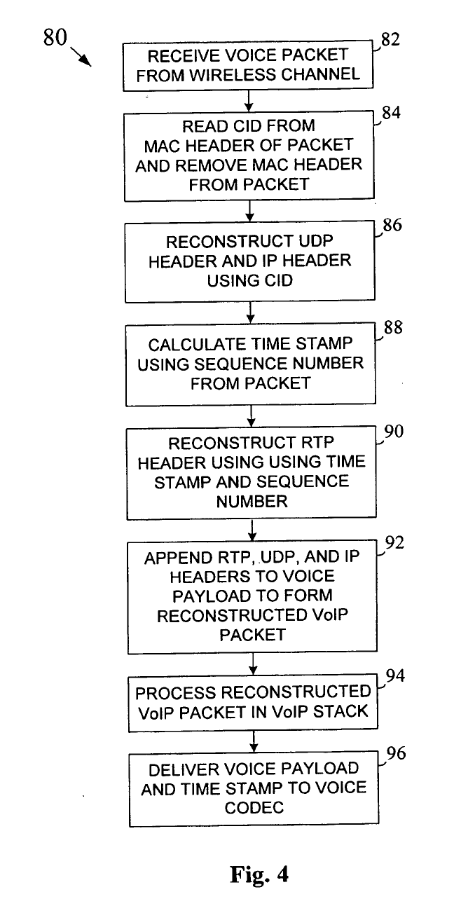

FIG. 4 is a flowchart illustrating a method 80 for use in processing a voice packet received from a wireless channel in accordance with an embodiment of the present invention. The method 80 may be used, for example, to process the packet transmitted into the wireless channel in the method 60 of FIG. 3, after reception. The method 80 is intended for use when the receiving node is a subscriber station. A voice packet is first received from a wireless channel (block 82). The packet may include at least a voice payload, an RTP sequence number, and a MAC header. The MAC header may include a CID that uniquely identifies a corresponding connection. The MAC header may also include error detection/correction information (e.g., a CRC value, etc.) for use in error detection/correction. Other information may also be present. After the packet is received, an error detection/correction operation (e.g., a cyclic redundancy check) may be performed using information from the MAC header. The CID may then be read from the MAC header of the packet and the MAC header may then be removed from the packet (block 84).

A UDP header and an IP header may then be reconstructed for the packet using the CID read from the MAC header (block 86). Any fields in the UDP header and the IP header for which no information is recoverable from the CID may be filled in with default (dummy) data values (e.g., ones, zeros, etc.). In at least one embodiment of the invention, a source IP address, a destination IP address, a source UDP port, and a destination UDP port are identified that correspond to the CID within the MAC header of the received packet. These values are then entered into corresponding fields of the UDP header and the IP header. The remaining fields may be filled with dummy values. In at least one embodiment, a lookup table approach is used to identify the information associated with the CID.

A time stamp may next be calculated for the packet using the sequence number within the received packet (block 88). In one approach, the time stamp is calculated by simply multiplying the RTP sequence number by the corresponding codec interval value. The codec interval is typically known a priori based on the codec type and the sampling interval. In at least one embodiment, a codec interval of 20 msec is used (although a wide range of other values may alternatively be used). An RTP header may next be reconstructed for the packet using the time stamp and the sequence number (block 90). Again, dummy values may be used to fill in any missing information in the reconstructed RTP header. The reconstructed RTP header, the reconstructed UDP header, and the reconstructed IP header may next be appended to the voice payload to form a reconstructed VoIP packet (block 92). The reconstructed VoIP packet may then be processed in the VoIP stack (block 94). The VoIP stack may then deliver the voice payload from the packet and the time stamp to a voice codec for conversion to an audible voice signal (block 96). The above process may be repeated for each voice packet received from the wireless channel.

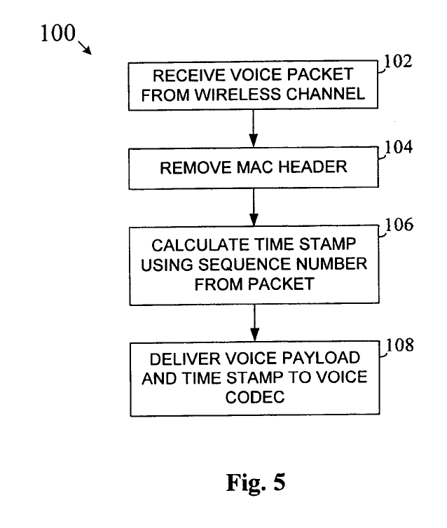

FIG. 5 is a flowchart illustrating a method 100 for use in processing a voice packet received from a wireless channel in accordance with an embodiment of the present invention. The method 100 may be used, for example, to process the packet transmitted into the wireless channel in the method 60 of FIG. 3. As in the method 80 of FIG. 4, the method 100 of FIG. 5 is intended for use when the receiving node is a subscriber station. A voice packet is first received from a wireless channel (block 102). As before, the voice packet may include a voice payload, a sequence number, and a MAC header. The MAC header is removed from the voice packet (block 104). A time stamp may next be calculated for the voice packet using the sequence number within the received packet (block 106). The voice payload from the packet and the calculated time stamp may then be delivered directly to a voice codec for conversion to an audible voice signal (block 108). The above process may be repeated for each VoIP packet received from the wireless channel.

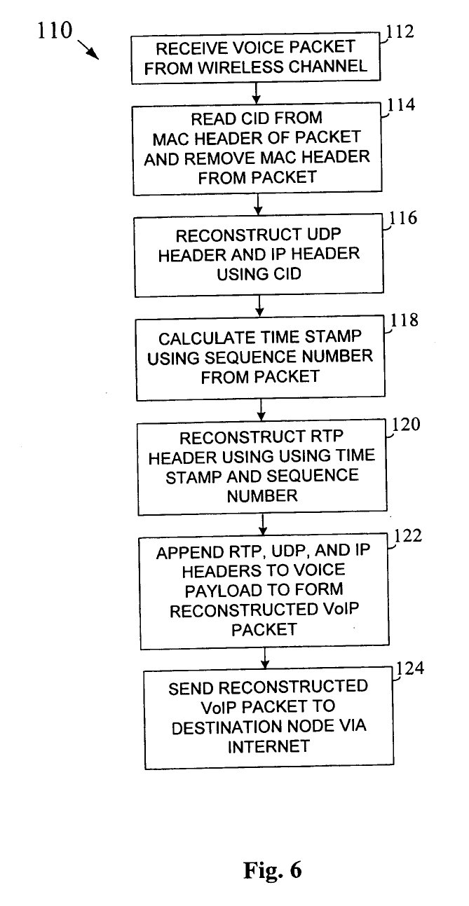

FIG. 6 is a flowchart illustrating a method 110 for use in processing a voice packet received from a wireless channel in accordance with an embodiment of the present invention. The method 110 may be used, for example, to process the packet transmitted into the wireless channel in the method 60 of FIG. 3, after reception. The method 110 is intended for use when the receiving node is a base station. The first six blocks 112, 114, 116, 118, 120, 122 of the method 110 that deal with the generation of the reconstructed VoIP packet are substantially the same as the corresponding blocks 82, 84, 86, 88, 90, 92 of the method 80 of FIG. 4. After the reconstructed VoIP packet has been formed, however, the packet is sent to the destination node via the Internet (or some other network) instead of being processed locally (block 124). Once at the destination node, the reconstructed packet may be processed in a VoIP stack and a VoIP codec. The above process may be repeated for each voice packet received from the wireless channel.

The techniques and structures of the present invention may be implemented in any of a variety of different forms. For example, features of the invention may be embodied within cellular telephones and other handheld wireless communicators; personal digital assistants (PDAs) having wireless capability; laptop, palmtop, desktop, and tablet computers having wireless capability; pagers; satellite communicators; cameras having wireless capability; audio/video devices having wireless capability; network interface cards (NICs) and other network interface structures; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-Ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data. In at least one form, the invention is embodied as a set of instructions that are modulated onto a carrier wave for transmission over a transmission medium.

It should be appreciated that the individual blocks illustrated in the block diagrams herein may be functional in nature and do not necessarily correspond to discrete hardware elements. For example, in at least one embodiment, two or more of the blocks in a block diagram are implemented in software within a single digital processing device. The digital processing device may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above. Hardware, software, firmware, and hybrid implementations may be used.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
receiving a packet from a wireless channel, said packet having a medium access control (MAC) header, a real time protocol (RTP) sequence number, and a voice payload, wherein said MAC header includes a connection identifier (CID) that uniquely identifies a connection associated with said packet; and
reconstructing a UDP header and an IP header for said packet using said CID.

2. The method of claim 1, further comprising:
calculating an RTP time stamp for said packet using said RTP sequence number.

3. The method of claim 2, further comprising:
reconstructing an RTP header for said packet using said RTP time stamp and said RTP sequence number.

4. The method of claim 3, further comprising:
removing said MAC header from said packet.

5. The method of claim 4, further comprising:
appending said reconstructed RTP header, said reconstructed UDP header, and said reconstructed IP header to said packet to form a reconstructed VoIP packet.

6. The method of claim 5, further comprising:
delivering said reconstructed VoIP packet to a VoIP stack to process said reconstructed RTP header, said reconstructed UDP header, and said reconstructed IP header.

7. The method of claim 6, wherein:
delivering said voice payload and said reconstructed RTP time stamp to a voice codec for conversion to an audible signal.

8. The method of claim 3, wherein:
reconstructing an RTP header includes entering dummy values in fields of said RTP header other than fields reserved for said RTP time stamp and said RTP sequence number.

9. The method of claim 1, wherein:
reconstructing a UDP header and an IP header for said packet using said CID includes determining a source IP address, a destination IP address, a source UDP port, and a destination UDP port associated with said CID.

10. The method of claim 1, wherein:
reconstructing a UDP header and an IP header for said packet using said CID includes entering dummy values in fields of said UDP header and said IP header for which said CID provides no information.

11. The method of claim 1, wherein:
receiving a packet from a wireless channel comprises receiving a packet that includes only said MAC header, said RTP sequence number, and said voice payload.

12. A method comprising:
receiving a packet from a wireless channel, said packet having a medium access control (MAC) header, a real time protocol (RTP) sequence number, and a voice payload, wherein said MAC header includes a connection identifier (CID) that uniquely identifies a connection associated with said packet; and
calculating an RTP time stamp for said packet using said RTP sequence number.

13. The method of claim 12, further comprising:
reconstructing a UDP header and an IP header for said packet using said CID.

14. The method of claim 12, further comprising:
delivering said voice payload and said RTP time stamp directly to a voice codec for conversion to an audible signal without first regenerating a UDP header or an IP header.

15. The method of claim 12, wherein:
said packet received from said wireless channel does not include an RTP header, a UDP header, or an IP header.

16. A method comprising:
obtaining a VoIP packet to be transmitted to a remote wireless entity through a wireless channel, said VoIP packet including a voice payload, an RTP header, a UDP header, and an IP header;
generating a CID to uniquely identify a corresponding connection using information within said UDP header and said IP header;
removing said UDP header and said IP header from said VoIP packet; and
generating a MAC header for said VoIP packet that includes said CID.

17. The method of claim 16, further comprising:
reading a sequence number from said RTP header of said VoIP packet;
removing said RTP header from said VoIP packet; and
appending said sequence number to said VoIP packet.

18. The method of claim 17, further comprising:
appending said MAC header to said VoIP packet; and
transmitting said packet into a wireless channel.

19. An apparatus comprising:
a flow classifier to generate a connection identifier (CID) for a VoIP packet that uniquely identifies a connection associated with said packet, said flow classifier using information within a UDP header and an IP header of said VoIP packet to generate said CID; and
a payload header suppressor to read a RTP sequence number from an RTP header of said VoIP packet, to remove said RTP header, said UDP header, and said IP header from said VoIP packet, and to append said RTP sequence number to said VoIP packet.

20. The apparatus of claim 19, further comprising:
a MAC encapsulator to generate an MAC header for said VoIP packet and to append said MAC header to said VoIP packet to form a modified VoIP packet, said MAC encapsulator to include said CID in said MAC header.

21. The apparatus of claim 20, wherein:
said MAC encapsulator is to include a cyclic redundancy check (CRC) value in said MAC header.

22. The apparatus of claim 21, further comprising:
a radio frequency (RF) transmitter to generate an RF signal to be transmitted into said wireless channel that includes said modified VoIP packet.

23. The apparatus of claim 22, wherein:
said RF transmitter is configured in accordance with the IEEE 802.16 wireless networking standard.

24. An apparatus comprising:
an RF receiver a receive a packet from a wireless channel, said packet having a medium access control (MAC) header, a real time protocol (RTP) sequence number, and a voice payload, wherein said MAC header includes a connection identifier (CID) that uniquely identifies a connection associated with said packet; and
a sequence number-to-time stamp converter to calculate an RTP time stamp for said packet using said RTP sequence number within said received packet.

25. The apparatus of claim 24, further comprising:
a voice codec to process the voice payload and the calculated RTP time stamp to generate an audible voice signal.

26. The apparatus of claim 24, wherein:
said sequence number to time stamp converter is part of a header reconstructor, said header reconstructor to reconstruct an RTP header, a UDP header, and an IP header for said received packet, wherein said header reconstructor reconstructs said RTP header using said RTP sequence number and said calculated RTP time stamp.

27. The apparatus of claim 26, wherein:
said header reconstructor reconstructs said UDP header and said IP header using information derived from said CID.

28. The apparatus of claim 26, wherein:
said header reconstructor fills in fields of said RTP header, said UDP header, and said IP header for which data is not available, with dummy values.

29. The apparatus of claim 26, wherein:
said header reconstructor appends said reconstructed RTP header, said reconstructed UDP header, and said reconstructed IP header to said voice payload to form a reconstructed VoIP packet.

30. The apparatus of claim 29, further comprising:
a VoIP stack to process said reconstructed VoIP packet.

31. The apparatus of claim 29, further comprising:
means for transmitting said reconstructed VoIP packet to a remote user through a wired network.

32. An article comprising a storage medium having instructions stored thereon that, when executed by a computing platform, operate to:
obtain a VoIP packet to be transmitted to a remote wireless entity through a wireless channel, said VoIP packet including a voice payload, an RTP header, a UDP header, and an IP header;
generate a CID to uniquely identify a connection associated with said VoIP packet using information within said UDP header and said IP header;
remove said UDP header and said IP header from said VoIP packet; and
generate a MAC header for said VoIP packet that includes said CID.

33. The article of claim 32, wherein said instructions further operate to:
read a sequence number from said RTP header of said VoIP packet;
remove said RTP header from said VoIP packet; and
append said sequence number to said VoIP packet.

34. The article of claim 33, wherein said instructions further operate to:
append said MAC header to said VoIP packet; and
transmit said VoIP packet with said MAC header and said sequence number appended thereto into a wireless channel.

35. A system comprising:
a flow classifier to generate a connection identifier (CID) for a VoIP packet that uniquely identifies a connection associated with said packet, said flow classifier using information within a UDP header and an IP header of said VoIP packet to generate said CID;
a payload header suppressor to read an RTP sequence number from an RTP header of said VoIP packet, to remove said RTP header, said UDP header, and said IP header from said VoIP packet, and to append said RTP sequence number to said VoIP packet; and
at least one dipole antenna to launch an RF signal having a modified VoIP packet into a wireless channel.

36. The system of claim 35, further comprising:
a MAC encapsulator to generate a MAC header for said VoIP packet and to append said MAC header to said VoIP packet to form a modified VoIP packet, said MAC encapsulator to include said CID in said MAC header.

37. The system of claim 36, wherein:
said MAC encapsulator is to include a cyclic redundancy check (CRC) value in said MAC header.

38. The system of claim 36, further comprising:
a radio frequency (RF) transmitter to generate an RF signal to be transmitted into said wireless channel that includes said modified VoIP packet, said RF transmitter being coupled to said at least one dipole antenna.
